(19) United States
(12) Patent Application Publication
(10) Pub. No.: US 2002/0036709 A1
(43) Pub. Date: Mar. 28, 2002

(54) TV broadcasting reception apparatus, TV broadcasting reception method, and recording medium for recording control progam thereof

(76) Inventor: Yusuke Nishida, Osaka (JP)

Correspondence Address: ROSENTHAL & OSHA L.L.P., 1221 MCKINNEY AVENUE, SUITE 2800, HOUSTON, TX, 77010, US

(21) Appl. No.: 09/962,821

(22) Filed: Sep. 25, 2001

(30) Foreign Application Priority Data
Sep. 26, 2000 (JP) P2000-292801

(51) Int. Cl. H04N 7/01; H04N 11/20; H04N 5/46

(52) U.S. Cl. 348/558; 348/555; 348/441

(57) ABSTRACT

A TV broadcasting reception apparatus 100 has a following function: when the same program is being broadcasted at the same time between digital TV broadcasting and analog TV broadcasting, even if the user selects reception of the analog TV broadcasting, the same program in the digital TV broadcasting is found out and the analog TV broadcasting is preferentially and automatically switched to the digital TV broadcasting. Further, the TV broadcasting reception apparatus 100 has a following function: when the same program is being broadcasted at the same time between digital TV broadcasting and analog TV broadcasting, in case that during receiving the digital TV broadcasting, the reception state of its digital TV broadcasting worsens so that the digital TV broadcasting cannot be received, the program in the digital TV broadcasting is preferentially and automatically switched to the same program in the analog TV broadcasting that has been previously searched.

### BACKGROUND OF THE INVENTION

1. Technical Field

The present invention relates to a TV broadcasting receiving apparatus such as a set-top box and a television, which can receive digital TV broadcasting and analog TV broadcasting; a TV broadcasting reception method; and a recording medium for recording its control program. Off course, this TV broadcasting reception apparatus includes a TV broadcasting receptible apparatus such as a compound apparatus into which a video recording/reproducing apparatus is incorporated, a single video recording/reproducing apparatus including a TV tuner, and a personal computer including a TV tuner.

2. Related Art

At the present time, digital TV broadcasting spreads, and Broadcasting stations that perform digital broadcasting broadcast frequently the same program at the same time between analog TV broadcasting and digital TV broadcasting. Namely, in the same main channel, between one analog TV broadcasting channel and one of some digital TV broadcasting channels, the same program is broadcasted frequently at the same time.

In a conventional TV broadcasting reception apparatus that can receive digital TV broadcasting and analog TV broadcasting, a user previously decides which broadcasting he receives, using a remote control transmitter or an input key. As long as the user does not change the decided broadcasting by the remote control transmitter or the input key, the broadcasting during reception is not switched between the digital TV broadcasting and the analog TV broadcasting.

[Problems to be solved]

Therefore, even if between the analog TV broadcasting and the digital TV broadcasting, there is the same program at the same time, in case that the user does not know it and specifies the reception of the analog TV broadcasting, he cannot watch the digital TV broadcasting that is high in display quality and remains watching the analog TV broadcasting that is low in display quality.

To the contrary, in case that the digital TV broadcasting is specified and watched, when a level of the received signal becomes below the predetermined level, video and audio (hereinafter referred to also as “video and the like”) are broken suddenly or the video and the like cannot be entirely obtained, which is different from a case of reception of the analog TV broadcasting. This is due to the following reason: Though the digital TV broadcasting is generally higher in display quality than the analog TV broadcasting because it processes digital signals, when it cannot discriminate a signal ┌1┘ from a signal ┌0┘ due to the decrease of the reception power, it cannot suddenly receive the video and the like. Accordingly, taking the reception state into consideration, the analog TV broadcasting may be higher in the display quality than the digital TV broadcasting.

In case that the video and the like are broken suddenly or cannot be entirely obtained, if the user does not know that the same program is being broadcasted at the same time also in the analog TV broadcasting, he fails to watch its program or watches it brokenly.

Further, even if the user know that the same program is broadcasted at the same time also in the analog TV broadcasting, it is necessary for him to switch a channel troublesomely. Therefore, it was a large problem that he cannot watch the video and the like till completion of switching.

Technology which relates to the invention somewhat is disclosed in Japanese Patent Laid-Open Nos. Hei 4-3614 and Hei 3-50975. However, in Japanese Patent Laid-Open No. Hei 4-3614, technology only on automatic selection of specified broadcasting by audio mode specification in a satellite broadcast receiver is disclosed. Further, in Japanese Patent Laid-Open No. Hei 3-50975, technology only on an automatic judgment circuit of EDTV/HDTV signals is disclosed, in which the HDTV/EDTV signals can be automatically judged and the EDTV/HDTV signals can be processed.

### SUMMARY OF THE INVENTION

A main object of the invention is to provide a TV broadcasting receiving apparatus, a TV broadcasting receiving method and a recording medium for recording its control program, in which in case that the same program is broadcasted at the same time between digital TV broadcasting and analog TV broadcasting, either broadcasting that is higher in display quality is preferentially and automatically received.

[Means for Solving the Problem]

In order to solve the above problem, a TV broadcasting reception apparatus according to the first aspect of the invention can receive digital TV broadcasting and analog TV broadcasting, and includes a comparison-judge section which compare-judges, during receiving analog TV broadcasting, whether a signal of this analog TV broadcasting is the same as a signal of digital TV broadcasting within the predetermined range, and a switch section which, when the comparison-judge section is judged that their signals are the same, switches the signal of the analog TV broadcasting to the signal of the digital TV broadcasting that is judged to be the same.

A TV broadcasting reception apparatus according to the second aspect of the invention can receive digital TV broadcasting and analog TV broadcasting, and includes a comparison-judge section which compare-judges, during receiving digital TV broadcasting, whether a signal of this digital TV broadcasting is the same as a signal of analog TV broadcasting within the predetermined range, a receiving state judge section which judges whether a signal level of the digital TV broadcasting under reception is below the predetermined level, and a switch section which, when the reception state judge section is judged it to be below the predetermined level, switches the signal of the digital TV broadcasting to the signal of the analog TV broadcasting that is judged to be the same.

In a TV broadcasting reception apparatus according to the third aspect of the invention, the aforesaid predetermined level is set to a threshold level in which the digital TV broadcasting can be received or cannot.

In a TV broadcasting reception apparatus according to the fourth aspect of the invention, the aforesaid predetermined range is the same main channel.

A TV broadcasting reception method according to the fifth aspect of the invention can a method in a TV broadcasting reception apparatus which can receive digital TV broadcasting and analog TV broadcasting. This method comprises the steps of compare-judging, during receiving analog TV broadcasting, a signal of the analog TV broadcasting with a signal of digital TV broadcasting within the predetermined range; and switching, when their signals have been judged to be the same, the signal of the analog TV broadcasting into the signal of the digital TV broadcasting that is judged to be the same.

A TV broadcasting reception method according to the sixth aspect of the invention is a method in a TV broadcasting reception apparatus which can receive digital TV broadcasting and analog TV broadcasting. This method comprises the steps of compare-judging, during receiving digital TV broadcasting, whether a signal of this digital TV broadcasting is the same as a signal of analog TV broadcasting within the predetermined range; judging whether a signal level of the digital TV during reception is below the predetermined level; and switching, when this signal level is judges to be below the predetermined level, the signal of the digital TV broadcasting into the signal of the analog TV broadcasting that is judged to be the same.

A recording medium for recording a control program of a TV broadcasting reception apparatus according to the seventh aspect of the invention records a control program for controlling by a computer a TV broadcasting receiving apparatus which can receive digital TV broadcasting and analog TV broadcasting. According to the control program, during receiving the analog TV broadcasting, whether a signal of the analog TV broadcasting is the same as a signal of digital TV broadcasting within the predetermined range is compare-judged, and when the signal is judged to be the same, the signal of the analog TV broadcasting is switched into the signal of the digital TV broadcasting that is judged to be the same.

A recording medium for recording a control program of a TV broadcasting reception apparatus according to the eighth aspect of the invention records a control program for controlling by a computer a TV broadcasting receiving apparatus which can receive digital TV broadcasting and analog TV broadcasting. According to this control program, during receiving the digital TV broadcasting, whether a signal of the digital TV broadcasting is the same as a signal of analog TV broadcasting within the predetermined range is compare-judged, whether a signal level of the digital TV broadcasting during reception is below the predetermined level is judged, and when the signal level is judged to be under the predetermined level, the signal of the digital TV broadcasting is switched into the signal of the analog TV broadcasting judged to be the same.

### BRIEF DESCRIPTION OF THE DRAWINGS

FIG. 1 is a schematic block diagram showing a TV broadcasting reception apparatus according to a mode for carrying out the invention.

FIG. 2 is a diagram showing a schematic operation flow of the TV broadcasting reception apparatus according to the mode for carrying out the invention.

FIG. 3 is a diagram showing another schematic operation flow of the TV broadcasting reception apparatus according to the mode for carrying out the invention.

### DETAILED DESCRIPTION OF THE PREFERRED EMBODIMENTS

[Mode for Carrying Out the Invention]

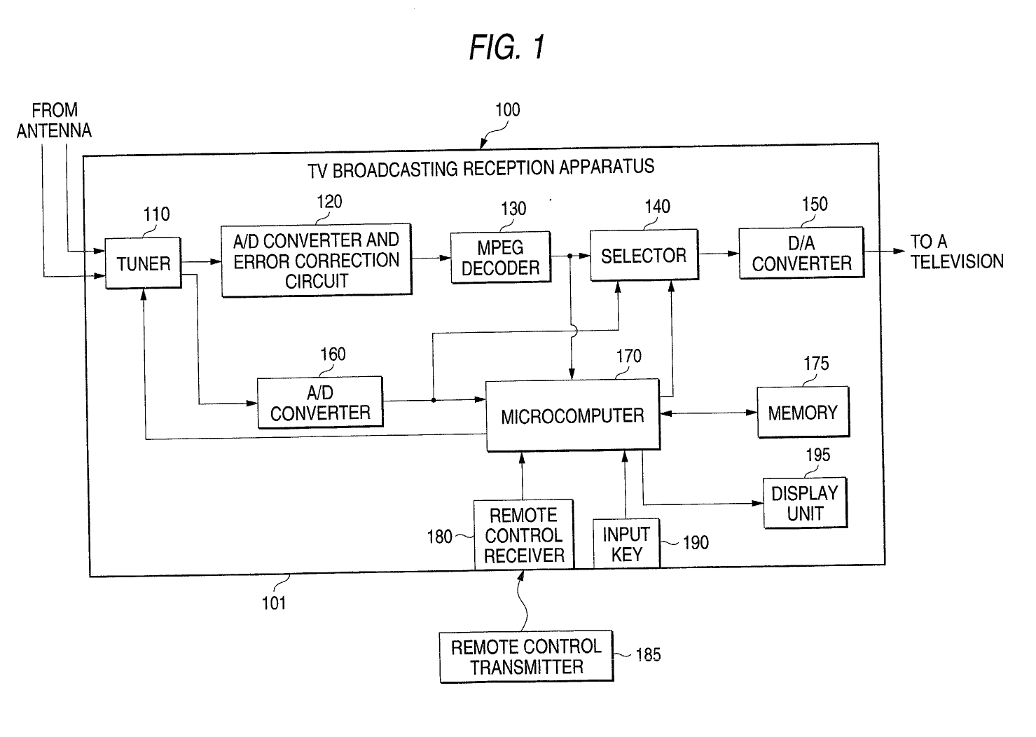

A TV broadcasting reception apparatus according to a mode for carrying out the invention will be described below with reference to FIGS. 1 to 3.

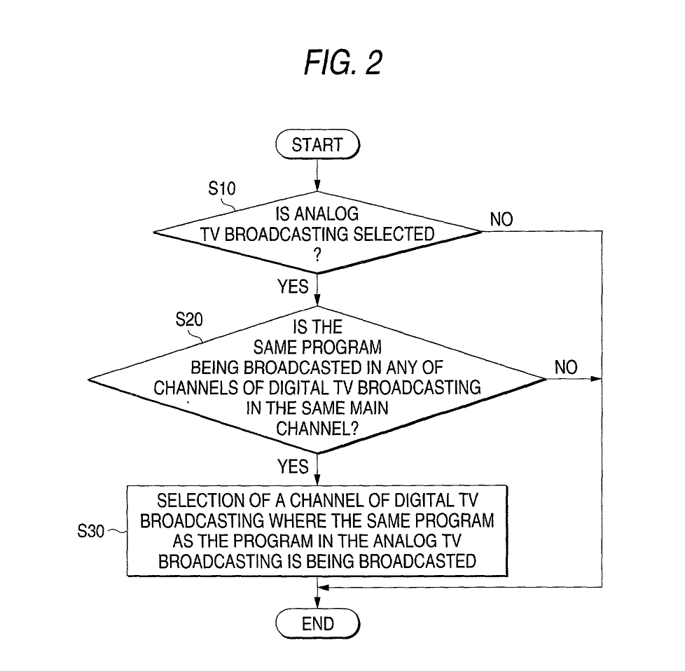

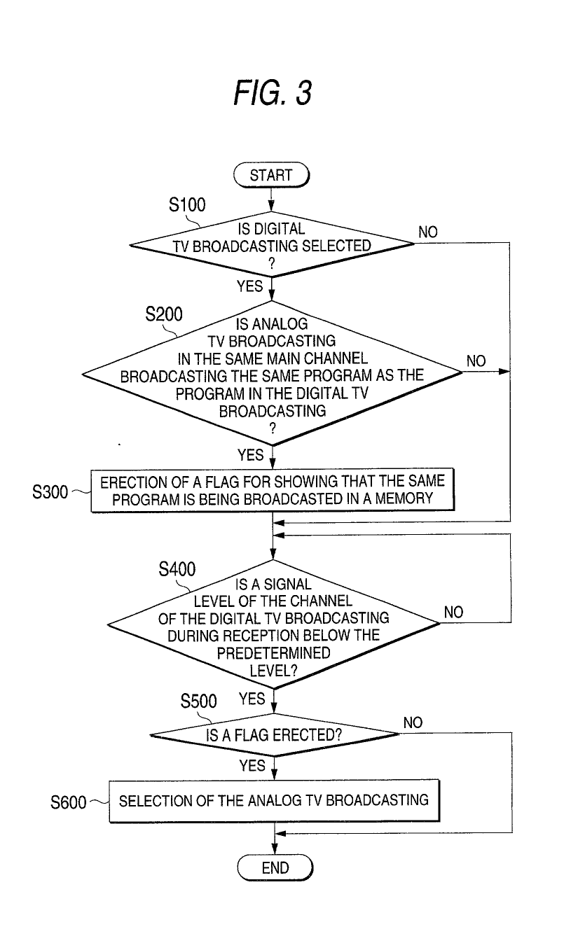

FIG. 1 is a schematic block diagram showing a TV broadcasting reception apparatus according to a mode for carrying out the invention, FIG. 2 is a diagram showing a schematic operation flow of the TV broadcasting reception apparatus according to the mode for carrying out the invention, and FIG. 3 is a diagram showing another schematic operation flow of the TV broadcasting reception apparatus according to the mode for carrying out the invention.

A TV broadcasting reception apparatus 100 according to the mode for carrying out the invention is a set-top box having a function of converting ATSC signals (digital signals) into NTSC signals (analog signals), that is, a NTSC signal reception-dedicated television connected to the outside, which enables reception of digital TV broadcasting.

This TV broadcasting reception apparatus 100 is characterized in that in case that the same program is broadcasted at the same time between digital TV broadcasting and analog TV broadcasting, either broadcasting that is higher in display quality can be preferentially and automatically received.

Specifically, the TV broadcasting reception apparatus 100 has a function of, in case that the same program is broadcasted at the same time in digital TV broadcasting and analog TV broadcasting, even if a user selects reception of the analog TV broadcasting, searching the same program in the digital TV broadcasting and switching the reception preferentially and automatically. Further, the TV broadcasting reception apparatus 100 has a function of, in case that the same program is broadcasted at the same time in digital TV broadcasting and analog TV broadcasting, when during reception of the digital TV broadcasting, the reception state of the digital TV broadcasting worsens so that it cannot be received, preferentially and automatically switching the program in the digital broadcasting to the same program in the analog TV broadcasting that has been previously searched.

The TV broadcasting reception apparatus 100 comprises a set-top box body 101 and a remote control transmitter 185 used with this box body.

The set-top box body 101 comprises a tuner 110, an A/D converter & error correction circuit 120, a MPEG decoder 130, a selector 140, a D/A converter 150, an A/D converter 160, a microcomputer 170, a memory 175, a remote control receiver 180, an input key 190, a display unit 195, and a power supply (not shown).

The tuner 110, to which an antenna is connected, is a general tuner that can receive digital TV broadcasting and analog TV broadcasting simultaneously. Accordingly, the tuner 110, upon reception of a channel specification (i.e., selection of channel) by the remote control transmitter 185 or the input key 190 through the microcomputer 170, performs a general processing such as taking-out of a signal of the specified channel from radio waves received by the antenna, and outputs its signal. The signal output of the digital TV broadcasting by the tuner 110 is input into the A/D converter & error correction circuit 120. Further, the signal output of the digital TV broadcasting from the tuner 110 is input into the A/D converter 160 & error correction circuit 120. Further, the signal output of the analog TV broadcasting from the tuner 110 is input into the A/D converter 160.

The A/D converter & error correction circuit 120 converts the signal of the digital TV broadcasting output from the tuner 110 into a digital signal and corrects errors.

The MPEG decoder 130 decodes an ATSC signal (digital signal) that is an output signal from the A/D converter & error correction circuit 120 into a NTSC signal (Here, this is in a state of digital signal).

The selector 140 switches, in accordance with an instruction from the microcomputer 170, the output signal from the MPEG decoder 130 and the output signal from the A/D converter 160.

The D/A converter 150 converts the output signal from the MPEG decoder 130 or the output signal from the A/D converter 160 into an analog signal. This analog signal is connectably output to an external television.

The A/D converter 160 converts a NTSC signal (analog signal) output from the tuner 110 into a digital signal.

The microcomputer 170 controls the whole of the set-top box body 101, into which a NTSC signal (digital signal) that is an output signal from the MPEG decoder 130 and is converted from an ATSC signal (digital signal) in digital TV broadcasting and a NTSC signal (digital signal) that is an output signal from the A/D converter 160 and is converted from a NTSC signal (analog signal) in analog TV broadcasting are input. Further, the microcomputer 170 receives a specification signal such as channel specification from the remote control transmitter 185 and the input key 190. Further, the microcomputer 170 transmits or receives signals between the memory 175 and it. Furthermore, the microcomputer 170 outputs data such as a channel in the display unit 195.

A memory (not shown) of the microcomputer 170 stores therein a program corresponding to operation flows shown in FIGS. 2 and 3, which will be described later, and a program corresponding to a conventional general function of the set-top box body.

The memory 175 stores whether there is a channel of the same program in the analog TV broadcasting as the program in the digital TV broadcasting, using a flag. Accordingly, though the memory 175 is separated from the microcomputer 170 on description, it is generally included in the microcomputer 170.

The contents in this memory 175, when the power supply of the set-top box body 101 is turned off, are cleared.

The remote control receiver 180 demodulates a signal from the remote control transmitter 185.

The input key 190 has a key and the like for selecting the analog TV broadcasting or the digital TV broadcasting.

The display unit 195 displays a selected channel during reception. The display unit 195 not only displays the channel but also may cause the user to readily recognize that the channel has been switched by turning on and off the channel display for a fixed time after switching of the channel. Further, the display unit 195 may display both the channel before change and the channel after change.

The remote control transmitter 185 has channel keys for selecting the analog TV broadcasting or the digital TV broadcasting.

The microcomputer 170 of the above members functions as a ┌comparison-judge section for compare-judging, during receiving analog TV broadcasting, whether a signal of this analog TV broadcasting is the same as a signal of digital TV broadcasting in the predetermined range┘ and a ┌comparison-judge section for compare-judging, during receiving digital TV broadcasting, whether a signal of this digital TV broadcasting is the same as a signal of analog TV broadcasting in the predetermined range┘. However, since the signals to be compared must be the same kind, the tuner 110, the A/D converter & error correction circuit 120, the MPEG decoder 130, and the A/D converter 160 are used together with the microcomputer.

Further, as a switching section, the microcomputer 170 and the selector 140 are used. Further, the microcomputer 170 is used as a ┌reception state judge section for judging whether the signal level in the digital TV broadcasting during reception is below the predetermined level┘. Furthermore, the predetermined range means the same main channel. The predetermined level is a threshold level meaning that the digital TV broadcasting can be received or cannot.

The operation of the thus constructed TV broadcasting reception apparatus 100 according to the mode for carrying out the invention will be described with reference to FIGS. 2 and 3.

Here, on description, the user selects, for example, a channel ┌3-0┘ of the analog TV broadcasting in a main channel ┌3┘ , and any of channels ┌3-1┘, ┌3-2┘, and ┌3-3┘ of the digital TV broadcasting.

Firstly, the operation flow in FIG. 2 will be described.

For example, the user specifies (selects) a channel ┌3-0┘ of the analog TV broadcasting with the remote control transmitter 185 or the input key 190 (hereinafter referred to as a ┌remote control transmitter 185 or the like┘). The microcomputer 170 instructs the tuner 110 to select the channel ┌3-0┘ of the analog TV broadcasting so as to become during reception, while it sets a contact of the selector 140 to a side where a signal of the analog TV broadcasting passes. Namely, during reception of the channel ┌3-0┘ of the analog TV broadcasting, a signal of the channel ┌3-0┘ of the analog TV broadcasting that is decided to be one of subjects of comparison by judgment described later can be always input into the microcomputer 170. Further, the contact of the selector 140 is set to a side where a signal of the analog TV broadcasting passes, and after channel selection by the remote control transmitter 185 or the like, the user can watch pictures very soon through a television connected to the outside.

Thereafter, on the channel selected by the user, whether analog TV broadcasting is selected is judged (S10). Namely, whether the channel specified by the remote control transmitter 185 or the like to the microcomputer 170 is a channel of the analog TV broadcasting is judged. Herein, since the channel ┌3-0┘ of the analog TV broadcasting is specified, the microcomputer 170 judges whether the channel ┌3-0┘ is a channel of the analog TV broadcasting.

Since the channel ┌3-0┘ is a channel of the analog TV broadcasting, a result of the judgment is YES.

On the basis of this result, next, whether the same program is being broadcasted in any of channels of the digital TV broadcasting in the same main channel as the program in the analog TV broadcasting is judged (S20).

Namely, the microcomputer 170 instructs the channel and the channel change so that channels ┌3-1┘, ┌3-2┘, and ┌3-3┘ of the digital TV broadcasting in the same main channel are received respectively for a fixed time, and compares an output signal from the MPEG decoder 130 with an output signal from the A/D converter 160, taking a difference between the two output signals. The digital TV broadcasting channel having no difference means that it is broadcasting the same program as the program of the analog TV broadcasting channel ┌3-0┘. When the digital TV broadcasting channel having no difference is found out, this judgment is completed. ┌No difference┘ includes a case where the difference is so small that there is virtually no difference.

For example, in case that the same program is being broadcasted in the channel ┌3-1┘ of the digital TV broadcasting as the program in the channel ┌3-0┘ of the analog TV broadcasting, when the judgment between the channel ┌3-0┘ of the analog TV broadcasting and the channel ┌3-1┘ of the digital TV broadcasting is performed, there is no difference between them. Therefore, at this time, a result of the judgment is YES.

On the basis of this result, next, a step (S30) of selecting a channel of the digital TV broadcasting in which the same program is being broadcasted as the program of the analog TV broadcasting is performed, and a series of steps ends. Namely, the microcomputer 170 instructs the tuner 110 to automatically select the channel ┌3-1┘ of the digital TV broadcasting in which the same program is being broadcasted as the program in the channel ┌3-0┘ of the analog TV broadcasting, gives such an instruction that a contact of the selector 140 is set to a side where a signal of a channel of the digital TV broadcasting passes, and instructs the display unit 195 to display the information of selecting the channel ┌3-1┘.

Accordingly, in case that the operation flow in FIG. 2 is operated, even if the user selects the channel ┌3-0┘ of the analog TV broadcasting, if there is a channel of the digital TV broadcasting in which the same program is being broadcasted as the program in the channel ┌3-0┘, its channel of the digital TV broadcasting (in this case, channel ┌3-1┘) is preferentially selected and the channel ┌3-0┘ is switched to that in the digital TV broadcasting, whereby the program in the channel ┌3-1┘ is received. Namely, in the television connected to the outside, the digital TV broadcasting that is broadcasting the aforesaid same program is preferentially received. Further, the user recognizes in the display unit 195 that the channel has been switched to a channel of the digital TV broadcasting.

In judgments of the steps S10 and S20, in case of NO, namely, in case the digital TV broadcasting is selected, or in case that the same program is not being broadcasted in the digital TV broadcasting in the same main channel as the program in the received analog TV broadcasting, any processing is not performed to lead to END. Namely, the channel of the received analog TV broadcasting (in this case, the channel ┌3-0┘), remains received. Namely, in the television connected to the outside, pictures in the channel of the analog TV broadcasting keeps received.

Next, a case in which the operation flow shown in FIG. 3 is processed and the operation flow shown in FIG. 2 is not processed will be described.

A user specifies (selects), for example, a channel ┌3-1┘ of digital TV broadcasting with the remote control transmitter 185 or the like. The microcomputer 170 instructs the tuner 110 to select the channel ┌3-1┘ of the digital TV broadcasting so as to become during reception, while it sets a contact of the selector 140 to a side where a signal of the digital TV broadcasting passes.

Thereafter, on the channel selected by the user, whether digital TV broadcasting is selected is judged (S100). Namely, whether the channel specified by the remote control transmitter 185 or the like to the microcomputer 170 is a channel of the digital TV broadcasting is judged. Herein, since the channel ┌3-1┘ of the digital TV broadcasting is specified, the microcomputer 170 judges whether the channel ┌3-1┘ is a channel of the digital TV broadcasting.

Since the channel ┌3-1┘ is a channel of the digital TV broadcasting, a result of the judgment is YES.

Accordingly, next, whether the same program is being broadcasted in a channel of analog TV broadcasting in the same main channel as the program in the digital TV broadcasting is judged (S200).

Namely, the microcomputer 170 instructs a channel so as to receive a channel ┌3-0┘ of the analog TV broadcasting in the same main channel ┌3┘ for a fixed time, and compares an output signal from the MPEG decoder 130 with an output signal from the A/D converter 160, taking a difference between the two output signals. No difference therebetween means that the channel ┌3-0┘ of the analog TV broadcasting is broadcasting the same program as the program of the digital TV broadcasting

For example, in case that the same program is being broadcasted in the channel ┌3-0┘ of the analog TV broadcasting as the program in the channel ┌3-1┘ of the digital TV broadcasting, since there is no difference, a result of the aforesaid judgment is YES.

On the basis of this result, next, a step (S300) of erecting a flag for indicating that the same program is being broadcasted in the memory is processed. Namely, by erecting the flag, the microcomputer 170 causes the memory 175 to store such information that the channel ┌3-0┘ of the analog TV broadcasting in which the same program is being broadcasted as the program in the channel ┌3-1┘ of the digital TV broadcasting exists.

Thereafter, whether a signal level of the channel of the digital TV broadcasting during reception is below the predetermined level is judged (S400). Namely, the microcomputer 170 judges always or at each fixed time whether the output signal from the MPEG decoder 130 is below a threshold level in which signals ┌0┘, ┌1┘ can be judged or cannot (namely, below a threshold level in which pictures can received or cannot).

In case that a result of this judgment is YES, i.e., the digital TV broadcasting during reception cannot be received, whether the flag is erected is judged (S500). Namely, the microcomputer 170 confirms whether the flag is erected in the memory 175 by reading out the memory contents.

In case that a result of this judgment is YES, i.e., the flag is erected, on the basis of this result, next, a step (S600) of selecting the aforesaid analog TV broadcasting is processed, and a series of steps ends. Namely, the microcomputer 170 instructs the tuner 110 to select the channel ┌3-0┘ of the analog TV broadcasting so as to enter in a receiving state, while it sets a contact of the selector 140 to a side where a signal of the analog TV broadcasting passes. Further, the microcomputer 170 instructs the display unit 195 to display the information of selecting the channel ┌3-0┘

Accordingly, in case that the operation flow in FIG. 3 is operated, when the user receives the channel ┌3-1┘ of the digital TV broadcasting and watches its channel at the television connected to the outside, if the reception level of the channel ┌3-1┘ becomes below the level at which the signal cannot be received, in case that there is analog TV broadcasting where the same program is being broadcasted, a channel is preferentially and automatically switched to its analog TV broadcasting channel and the analog TV broadcasting is received. Therefore, the user can remain watching the television in a state where the pictures are not broken. Further, the user recognizes in the display unit 195 that the channel has been switched to the analog TV broadcasting channel.

In the judgments of the steps S100 and S200, in case of No, the processing jumps next the step S300. Further, in the judgment of the step 500, in case of No, the processing ends, and since there is not the same program at the same time, the received digital TV broadcasting cannot be received similarly to the conventional case or can be watched brokenly.

In the above description, the operation flow in FIG. 2 and the operation flow in FIG. 3 function separately, however, for example, the operation flow in FIG. 3 may be performed sequentially to the operation flow in FIG. 2. This is due to the following reason: after the user specified the analog TV broadcasting, even if a channel is automatically switched preferentially to a channel of the digital TV broadcasting that is broadcasting the same program, if the reception state of its digital TV broadcasting thereafter worsens, it is preferable to return the channel to the channel of the analog TV broadcasting. Further, the operation flow in FIG. 2 and the operation flow in FIG. 3 may be looped so that the processing returns to START of the operation flow in FIG. 2 after END of the operation flow in FIG. 3. This is because in case that the reception level of the digital TV broadcasting recovers in some degree, it is preferable to switch from the analog TV broadcasting to the digital TV broadcasting.

The constitution or the like in the TV broadcasting reception apparatus 100 according to the mode for carrying out the invention may be changed as follows.

(1) In the operation flow of FIG. 3, in case that the judgments in the steps S100 and S200 are NO, the processing may jump not next the step S300 but next the step S600.

(2) Since possibility that the same program is being broadcasted at the same time in another main channel is generally low, it is preferable from a viewpoint of a small judgment range that the aforesaid predetermined range is taken as the same main channel. However, the predetermined range may include another main channel. In this case, the flag had better to be erected in a memory address assigned to each channel, whereby the user knows which channel is broadcasting the same program.

(3) If the processing concentrates on the microcomputer 170 too much, a part of the processing may be allotted to a sub-microcomputer and data communication may be performed between the sub-microcomputer and the microcomputer 170 if necessary. Further, the processing may not be always performed by a microcomputer such as the microcomputer 170 but the similar function may be performed by a gate array or the like.

(4) The judgment of the step S20 of the operation flow in FIG. 2 is performed preferably at the channel selecting time, however it may be performed after a while after the channel selection.

Otherwise, thereafter, even if the result of the judgment of the step S20 is NO, the processing may be returned to a head of the step S20 many times.

If the judgment of the step S20 is performed only at the channel selecting time, in case that a commercial program (CM) is broadcasted at that time, since there is a little possibility that CM in the analog TV broadcasting is different from CM in the digital TV broadcasting though a possibility that they are usually the same is very high, if they are different, the function does not act well. Therefore, the judgment had better to be performed for caution's sake also when CM is not be broadcasted.

Since CM does not continue for a long time, the aforesaid “sometimes” maybe taken as “at each time of CM that will continue for a longest time” or “at each time longer a little than the above CM time”. Further, it may be taken as “at each the shortest CM time”, as “at each half time of the shortest CM”, or as “always”. The reason why the judgment is performed sometimes or always is that while the same channel is set for a long time, a program changes to a next program and the judgment has better to be performed also at this time. The aforesaid “sometimes” may be taken as “each time for a switchover between a program (not including CM) and CM using a section having a function of not-recording CM in video”, instead of “at each fixed time”.

(5) In case of taking a very rare case in which the same CM is being broadcasted in plural channels into consideration, the following processing is preferable.

For example, in case that the processing of the step S20 is performed in the operation flow in FIG. 2, not only a first channel of the digital TV broadcasting in the same main channel in which the same program (in this case, the same CM) is being broadcasted is judged to proceed to the step S30, but also all the channels in the digital TV broadcasting in the same main channel are compared. Further, a memory is provided, which has a memory address in which a flag is erected at each channel of the digital TV broadcasting.

As a result of the comparison on all the channels in the digital TV broadcasting in the same main channel, when the plural flags are erected, it is judged that the same CM is being broadcasted. In case that only a flag is erected, a channel corresponding to the memory address of its flag is broadcasting the same program as the program of the analog TV broadcasting. When the plural flags are erected, the comparison is repeated again till only one flag is erected, and thereafter, the processing proceeds to the step S30.

(6) Ina television of a type mounted on a car or a portable type, the analog TV broadcasting does not always keep received after channel selection. Therefore, the reception level of the analog TV broadcasting may be confirmed at each fixed time or always. However, also in case of the fixed apparatus, the reception level of the analog TV broadcasting may be confirmed at each fixed time or always.

(7) In the above description, a NTSC system is typical of the analog TV broadcasting, however other system than this system, for example, a PAL system or the like may be used similarly, needless to say.

(8) The invention is not limited to the above-described set-top box, but may be applied to a TV broadcasting reception apparatus such as a television, a compound apparatus into which a video recording/reproducing apparatus is incorporated, a single video recording/reproducing apparatus including a TV tuner, and a personal computer including a TV tuner, needless to say.

[Effect of the Invention]

As described above, a TV broadcasting reception apparatus according to the first aspect of the invention can receive digital TV broadcasting and analog TV broadcasting, and includes a comparison-judge section which compare-judges, during receiving analog TV broadcasting, whether a signal of this analog TV broadcasting is the same as a signal of digital TV broadcasting within the predetermined range, and a switch section which, when this comparison-judge section judges that their signals are the same, switches the signal of the analog TV broadcasting to the signal of the digital TV broadcasting that is judged to be the same.

Accordingly, in case of the TV broadcasting reception apparatus according to the first aspect of the invention, when the same program is being broadcasted at the same time between the digital TV broadcasting and the analog TV broadcasting, even if the user selects the analog TV broadcasting to receive it, the same program in the digital TV broadcasting is searched and the analog TV broadcasting is preferentially and automatically switched to the digital TV broadcasting. Accordingly, even if the user does not know that the same program is being broadcasted at the same time in the digital TV broadcasting and selects the analog TV broadcasting, the program in the analog TV broadcasting is automatically and preferentially switched to the same program in the digital TV broadcasting. Therefore, the user can obtain display of high quality without trouble.

A TV broadcasting reception apparatus according to the second aspect of the invention can receive digital TV broadcasting and analog TV broadcasting, and includes a comparison-judge section which compare-judges, during receiving digital TV broadcasting, whether a signal of this digital TV broadcasting is the same as a signal of analog TV broadcasting within the predetermined range, a receiving state judge section which judges whether a signal level of the digital TV broadcasting under reception is below the predetermined level, and a switch section which, when this reception state judge section judges it to be below the predetermined level, switches the signal of the digital TV broadcasting to the signal of the analog TV broadcasting that is judged to be the same.

Accordingly, in the TV broadcasting reception apparatus according to the second aspect of the invention, when the same program is being broadcasted at the same time between the digital TV broadcasting and the analog TV broadcasting, in case that during receiving the digital TV broadcasting, the reception state of its digital TV broadcasting worsens so that the digital TV broadcasting cannot be received, the program in the digital TV broadcasting is preferentially and automatically switched to the same program in the analog TV broadcasting that has been previously searched. Accordingly, when the reception state of the digital TV broadcasting worsens so that the digital TV broadcasting cannot be received, it is not necessary for the user to find out confusedly the same program in the analog TV broadcasting from a program table. Trouble is saved. Further, when the reception state of the digital TV broadcasting worsens so that the digital TV broadcasting cannot be received, in case that the user does not know that there is the same program in the analog TV broadcasting, he conventionally failed to watch its program. However, as long as the analog TV broadcasting can be received, he can keep watching the program. Further, since the digital TV broadcasting can be switched to the analog TV broadcasting in a moment, as long as the analog TV broadcasting can be received, he can keep watching the program.

In a TV broadcasting reception apparatus according to the third aspect of the invention, the predetermined level is set to a threshold level meaning that the digital TV broadcasting can be received or cannot.

Therefore, in case of the TV broadcasting reception apparatus according to the third aspect of the invention, as soon as the received digital TV broadcasting reaches the level in which the digital TV broadcasting cannot be received, the program in the digital TV broadcasting can be preferentially and automatically switched to the program in the analog TV broadcasting which has been previously found out. Accordingly, the user can keep watching the program nearly unbrokenly.

In a TV broadcasting reception apparatus according to the fourth aspect of the invention, the predetermined range is the same main channel.

Therefore, in case of the TV broadcasting reception apparatus according to the fourth aspect of the invention, since the aforesaid range is narrow, this apparatus manages with a short processing time.

TV broadcasting reception methods according to the fifth and the sixth aspects of the invention have respectively the effects similar to the effects in the TV broadcasting reception apparatuses according to the first and second aspects of the invention.

Recording media for recording a control program of a TV broadcasting reception apparatus according to the seventh and eighth aspects of the invention have respectively the effects similar to the effects in the TV broadcasting reception apparatuses according to the first and second aspects of the invention.

What is claimed is:

1. A TV broadcasting reception apparatus which receives digital TV broadcasting and analog TV broadcasting, comprising:
comparison-judge section which compare-judges, during receiving analog TV broadcasting, whether a signal of the analog TV broadcasting is the same as a signal of digital TV broadcasting within the predetermined range; and
switch section which, when said comparison-judge section judges that the signals are the same, switches the signal of the analog TV broadcasting into the signal of the digital TV broadcasting that is judged to be the same.

2. A TV broadcasting reception apparatus which receives digital TV broadcasting and analog TV broadcasting, comprising:
comparison-judge section which compare-judges, during receiving digital TV broadcasting, whether a signal of the digital TV broadcasting is the same as a signal of analog TV broadcasting within the predetermined range;
receiving state judge section which judges whether a signal level of the digital TV broadcasting that is received is below the predetermined level; and
switch section which, when said receiving state judge section judges that said receiving state judge section judges the signal level of the digital TV broadcasting to be below the predetermined level, switches the signal of the digital TV broadcasting into the signal of the analog TV broadcasting that is judged to be the same.

3. The TV broadcasting reception apparatus according to claim 2, wherein
the predetermined level is set to be a threshold level representing that the digital TV broadcasting is received or not.

4. The TV broadcasting reception apparatus according to claim 1, wherein
the predetermined range is the same main channel.

5. A TV broadcasting reception method in a TV broadcasting reception apparatus which receives digital TV broadcasting and analog TV broadcasting, comprising the steps of:
compare-judging, during receiving analog TV broadcasting, a signal of the analog TV broadcasting with a signal of digital TV broadcasting within the predetermined range; and
switching, when the signals is judged to be the same, the signal of the analog TV broadcasting into the signal of the digital TV broadcasting that is judged to be the same.

6. A TV broadcasting reception method in a TV broadcasting reception apparatus which receives digital TV broadcasting and analog TV broadcasting, comprising the steps of:
compare-judging during receiving digital TV broadcasting whether a signal of the digital TV broadcasting is the same as a signal of analog TV broadcasting within the predetermined range;
judging whether a signal level of the digital TV during reception is below the predetermined level; and
switching, when the signal level is judges to be below the predetermined level, the signal of the digital TV broadcasting into the signal of the analog TV broadcasting that is judged to be the same.

7. A recording medium for recording a control program of a TV broadcasting reception apparatus, which records a control program for controlling by a computer a TV broadcasting reception apparatus capable of receiving digital TV broadcasting and analog TV broadcasting, wherein
according to the control program,
during receiving the analog TV broadcasting, whether a signal of the analog TV broadcasting is the same as a signal of digital TV broadcasting within the predetermined range is compare-judged; and
when the signals are judged to be the same, the signal of the analog TV broadcasting is switched into the signal of the digital TV broadcasting that judges to be the same.

8. A recording medium for recording a control program of a TV broadcasting reception apparatus, which records a control program for controlling by computer a TV broadcasting reception apparatus which receives digital TV broadcasting and analog TV broadcasting, wherein
according to the control program,
during receiving the digital TV broadcasting, whether a signal of the digital TV broadcasting is the same as a signal of analog TV broadcasting within the predetermined range is compare-judged;
whether a signal level of the digital TV broadcasting during reception is below the predetermined level is judged; and
when the signal level is judged to be under the predetermined level, the signal of the digital TV broadcasting is switched into the signal of the analog TV broadcasting that is judged to be the same.

9. The TV broadcasting reception apparatus according to claim 2, wherein
the predetermined range is the same main channel.
